(19) United States
(12) Patent Application Publication
(10) Pub. No.: US 2022/0294825 A1
(43) Pub. Date: Sep. 15, 2022

(54) TRUSTED DYNAMIC SERVER IDENTIFICATION SYSTEM AND METHOD

(71) Applicant: NOVIFLOW INC., Montreal (CA)

(72) Inventor: Marc Théberge, Canton de Hatley (CA)

(21) Appl. No.: 17/654,416

(22) Filed: Mar. 11, 2022

Related U.S. Application Data
(60) Provisional application No. 63/160,122, filed on Mar. 12, 2021.

(51) Int. Cl. H04L 9/40

(52) U.S. Cl. CPC H04L 63/166; H04L 63/0435; H04L 63/0236; H04L 63/0823

(57) ABSTRACT

A novel approach to dynamically build and maintain a trusted list of IP addresses is described. Using programmable Software Defined Networking (SDN) switch it is possible to duplicate the TLS Client Hello packets (flow establishments packets) and have the copy forwarded to a Verifier Process that cryptographically verifies the identity of the destination IP address together with its claimed domain name. Once the verification concludes that the IP address does indeed belong to a certain domain, it can compare it with a list of allowed listed domain names and decide to add the IP Address or not to the allow list.

During the verification process, normal packet flow occurs. That is, packets would normally flow from a TLS application (often a web browser) to a TLS termination point (often a web server) via at least one cyber-security device (often a firewall). However, once the verification process is completed and the destination IP address is added to the allow list, the traffic is re-directed inside the SDN switch to effectively bypass portions or the entire security service chain (chain of security services that normal traffic has to flow through: e.g. for HTTPS traffic: firewall, decryption device, Web Application Firewall).

### CROSS REFERENCE TO RELATED APPLICATIONS

This application claims benefit, under 35 U.S.C. § 119(e) of U.S. provisional application Ser. No. 63/160,122 filed on Mar. 12, 2021 and which is incorporated herein in its entirety by reference.

### FIELD OF THE INVENTION

Network devices such as web browsers and servers often communicate via firewalls or the like.

### BACKGROUND TO THE INVENTION

In a Wide Area Networked (WAN) setting such as the Internet networked devices such as client applications and servers communicate with each other via transport connections which provide end-to-end connectivity. A suite of other features are typically available such as end-to-end encryption and the like which improve reliability of the connections.

Prior art security services rely on Domain Name System (DNS) queries and pre-built, published lists of IP addresses for specific domain names to identify the service end point. Although the responses to such DNS queries are generally timely, they are often incomplete. Additionally, pre-built published lists are often outdated as well as being incomplete. As such, the trust level which would be required to place an Internet Protocol (IP) address on an allow list to bypass security devices is not met and as a result such allow lists are seldom used.

What is needed therefore, and an object of the present, is a system and method that carries out constant, asynchronous lookup and cryptographic checks on the domain name owner of an IP address to provide a high degree of assurance in real time for a given flow of data. This provides the ability to inherently trust certain flows thereby allowing certain trusted domain names to bypass security services. The resultant reduction of traffic flowing to security devices allows for significant savings in security services costs to be realised.

### SUMMARY OF THE INVENTION

In order to address the above and other drawbacks, there is provided a method for forwarding packets received at an intermediate security device in a system comprising at least one client device communicating a series of packets to at least one destination server device via the intermediate security device. The method comprises for flow establishment packets received at the intermediate security device: forwarding a duplicate of each of the flow establishment packets to a verifier process, the verifier process cryptographically verifying an identity of a destination IP address and claimed domain name of the flow establishment packets, and adding verified ones of the IP destination addresses to a list of trusted IP addresses, for packets other than flow establishment packets received at the intermediate security device: comparing a destination IP address of each of the packets with the list of trusted IP addresses, forwarding each of the packets without a trusted destination IP address to an addressed one of the at least one destination server device via a security service chain, and forwarding each of the packets with a trusted destination IP address to the addressed one of the at least one destination server device while bypassing the security service chain.

There is also provided a system comprising at least one client device, at least one server device, and an intermediate security device for forwarding packets received from the at least one client device to the at least one server and comprising a security service chain, wherein for flow establishment packets, the intermediate security device forwards a duplicate of each of the flow establishment packets to a verifier process, the verifier process cryptographically verifying an identity of a destination IP address and claimed domain name of the flow establishment packets, and adds verified ones of the IP destination addresses to a list of trusted IP addresses, wherein for packets other than flow establishment packets, the intermediate security device compares a destination IP address of each of the packets with the list of trusted IP addresses, forwards each of the packets without a trusted destination IP address to an addressed one of the at least one server via the security service chain, and forwards each of the packets with a trusted destination IP address to the addressed one of the at least one server while bypassing the security service chain.

### BRIEF DESCRIPTION OF THE DRAWINGS

FIG. 1 provides a schematic diagram of a trusted dynamic server identification system in accordance with an illustrative embodiment of the present invention;

FIG. 2 provides an alternative schematic diagram of a trusted dynamic server identification system in accordance with an illustrative embodiment of the present invention;

FIG. 3 provides a schematic diagram of an intermediate device in a trusted dynamic server identification system in accordance with an illustrative embodiment of the present invention;

FIG. 4 provides a flow chart of a verification process in a trusted dynamic server identification system in accordance with an illustrative embodiment of the present invention; and

FIG. 5 provides an alternative schematic diagram of an intermediate device in a trusted dynamic server identification system in accordance with an illustrative embodiment of the present invention.

### DETAILED DESCRIPTION OF THE ILLUSTRATIVE EMBODIMENTS

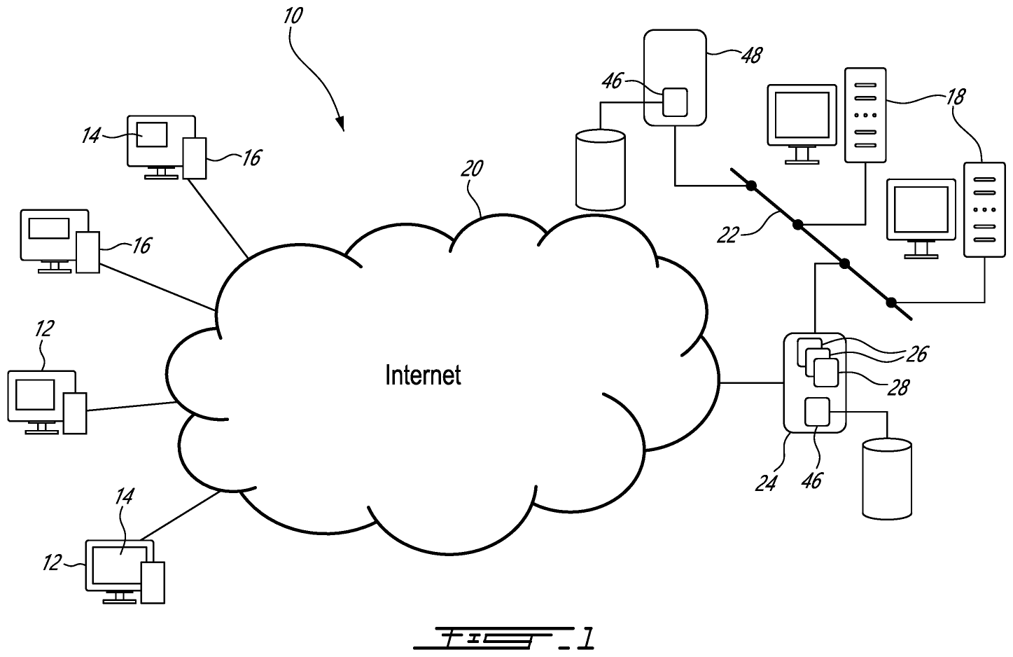

Referring now to FIG. 1, a trusted dynamic server identification system, generally referred to using the reference numeral 10, will now be described. The system 10 comprises a plurality of client devices 12 each illustratively comprising an application (in some embodiments a Transport Layer Security (TLS) application) such as a web browser application 14 running on a personal computer 16 or smartphone (not shown) or the like of which are communicating with at least one of a plurality of server devices 18 (in some embodiments a TLS termination device), each comprising a termination point (in some embodiments a TLS termination point), such as a load balancer, web server or the like via a WAN such as the Internet 20 or the like.

Still referring to FIG. 1, the server devices 18 are illustratively connected to the Internet 20 via a Local Area Network (LAN) 22 and an intermediate device 24 which comprises inter alia a security service chain 26 comprising one or more security services 28, such as a firewall, decryption device, web application firewall and the like and through which, as will be discussed in more detail below, non-verified traffic flows in real time. As will also be discussed in more detail below the intermediate device 24 also comprises a bypass (not shown) through which verified traffic flows in real-time.

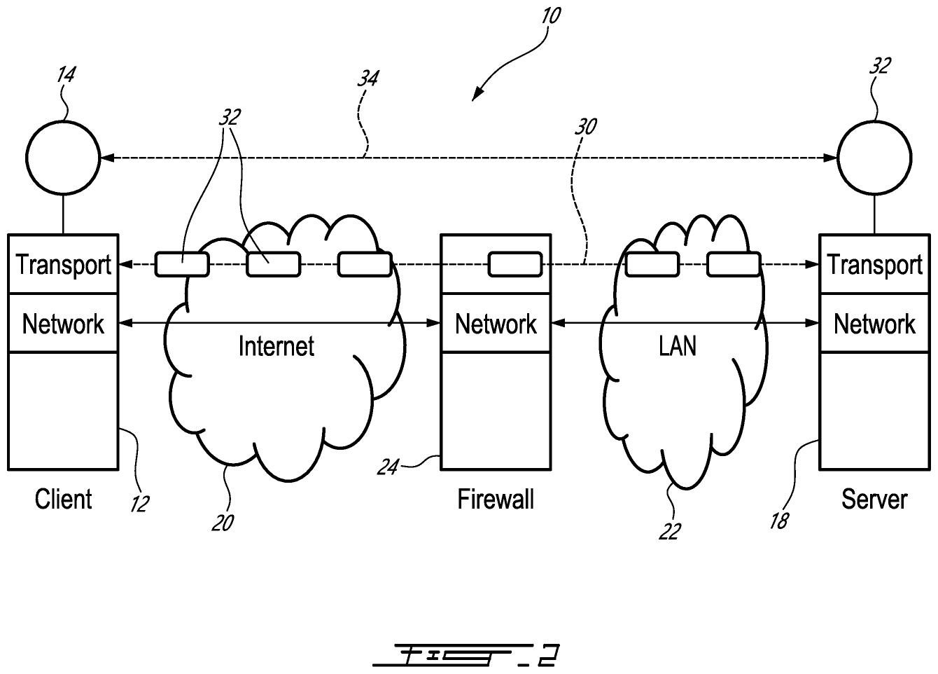

Referring to FIG. 2 in addition to FIG. 1, client devices 12 communicate with the server devices 18 by first establishing logical end-to-end connections 30 via which packets 32 can be transmitted and which are identified inter alia by a source IP address and a destination IP address. In a particular embodiment the payload data carried by the packets 32 is encrypted and such that it cannot be understood if intercepted. As such, the data payload is only understandable by the communicating applications, such as a web-browser application 14 communicating with a web server 32 via an encrypted logical connection 34 such as that provided by SSL and HTTPS.

Still referring to FIG. 2 in addition to FIG. 1, packets 32 originating at the client device 12 in some embodiments are relayed via the Internet 20 to the intermediate device 24 and subsequently relayed to the server device 18 via the LAN 22.

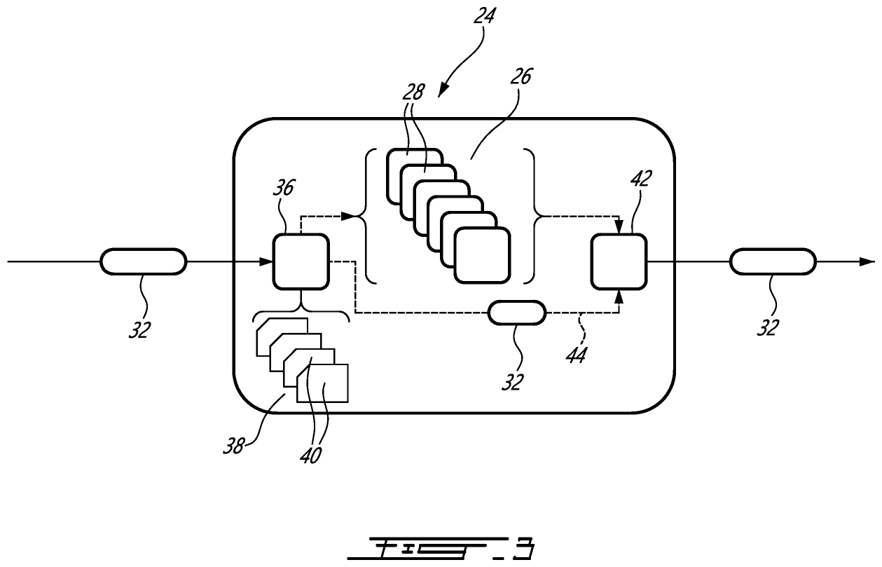

Referring now to FIG. 3 in addition to FIG. 2, in the intermediate device 24 the headers of a received packet 32 are received at an input interface 36 and inspected to identify the destination IP address (for example the IP address of the server device 18). The destination IP address is compared to a list 38 of trusted or verified IP addresses 40. If the destination IP address is not within the list 38 of trusted IP addresses 40, the received packet 32 is relayed towards an output interface 42 and the server device 18 identified by the destination IP address via the security service chain 26, which as described above comprises one or more security services 28 such as a firewall, decryption device, web application firewall and the like. If the destination IP address of the received packet 32 is within the list 38 of verified IP addresses 40, the destination IP address of the received packet 32 is considered verified and the received packet 32 is relayed towards the output interface 42 and the server device 18 identified by the destination IP address via a bypass 44 and such that the received packet 32 is not subject to the security service chain 26.

Referring back to FIG. 1 in addition to FIG. 3, in order to build and maintain the list 38 of trusted IP address 40, in an illustrative embodiment the headers of the received packet 32 are examined to identify the packet type. Recognition of the packet type as a flow establishment packet (in some embodiments a TLS Client Hello packet) triggers the generation of a duplicate of the received flow establishment packet 32 which is transferred in real time to a verifier process 46 while the original received flow establishment packet 32 is relayed in real time towards the output interface 42 and the server device 18 identified by the destination IP address via the security service chain 26. Until the destination IP address is verified and added to the list 38 of verified IP addresses 40, subsequent packets 32 received at the input interface 36 and destined for the server device identified by the unverified IP address are relayed towards the output interface 42 via the security service chain 26. Of note is that the verifier process 46 may form part of the intermediate device 24 or may be part of an external verification system 48, for example interconnected with the intermediate device 24 via the LAN 22.

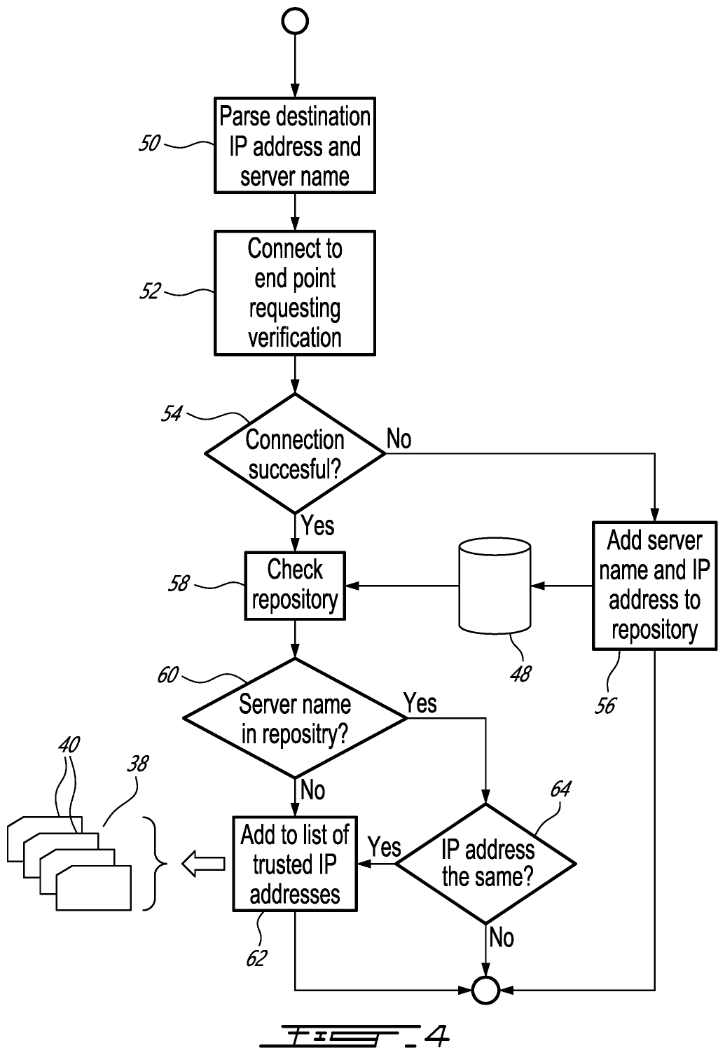

Referring now to FIG. 4 in addition to FIGS. 1 and 3, in the verifier process 46 the duplicate flow establishment packet is parsed 50 to extract the intended destination IP address and intended server name (which is in some embodiments available in the server_name extension of a TLS Client Hello packet). Using this information, the verifier process 46 builds a separate transport connection to the server device 18 and requests a verification connection 52, 54 (in some embodiments a TLS connection) to the termination end point (in some embodiments a TLS termination point) identified by the intended destination IP address, while requesting (full) cryptographic verification, in some embodiments including Certification Revocation List (CRL) checks. The verifier process 46 maintains a repository 48 of server_names and destination IP addresses where verification had been previously requested and for which the verification connection could not be successfully established. If a connection to the termination end point is unsuccessful the server_name and the IP address pair are added 56 to the repository 48. If establishment of the verification connection to the termination end point is successful under the prescribed conditions, the destination IP address server_name is considered potentially trusted. The repository 48 is checked 58 to identify entries with the same server_name. If there are no entries for the server name in the repository 60 then the server_name and IP address are considered verified and the IP address is added 62 to the list 38 of trusted IP address 40. If there is already an entry for the server_name in the repository the IP addresses are compared 64. If the IP addresses are the same then the IP address is added 62 to the list 38 of trusted IP address 40.

Still referring back to FIG. 3, as discussed above once a destination IP address is added to the list 38 of trusted IP addresses 40, further packets received at the input interface 36 destined for that IP address are redirected to bypass the security service chain 26.

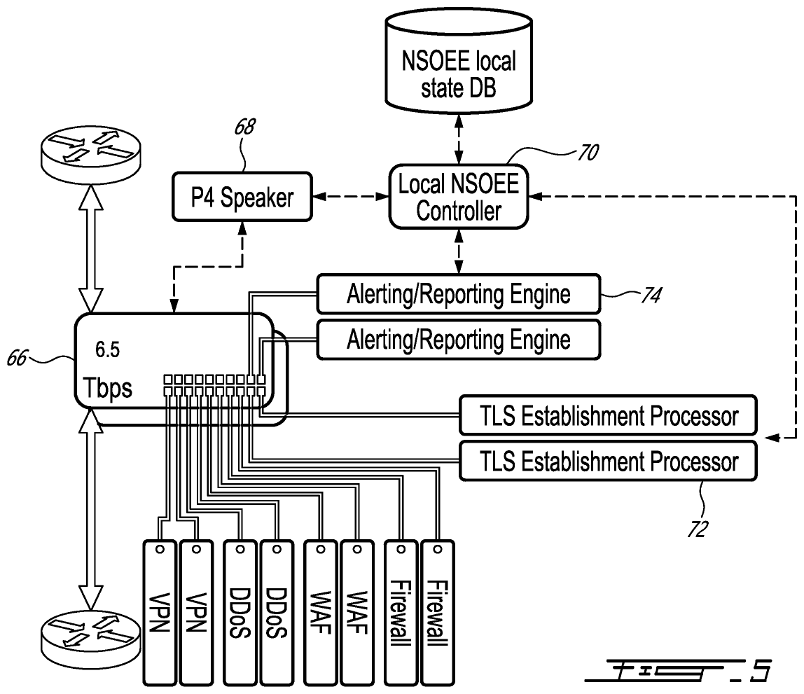

Referring now to FIG. 5 in addition to FIG. 3, in particular embodiment the trusted dynamic server identification system 10 can be implemented in a P4 (Programming Protocol-independent Packet Processors) programmable Software Defined Networking (SDN) switch 66 comprising P4.

Still referring to FIGS. 3 and 5, the P4 Speaker 68 manages the control plane of the switch by allowing P4 program upload and match-action table management of the SDN switch. The P4 Speaker simplifies interactions between the NSOEE Controller 70 and the SDN switch 66. Alternatively, this can be implemented directly using the gRPC Network Operations Interface (GNOI) and gRPC Network Management Interface (GNMI), interfaces provided by the SDN switch 66.

Still referring to FIGS. 3 and 5, the Local NSOEE Controller 70 is responsible for managing the allow and deny lists 38, as well as the security service chains 26. Both the Domain Name Allow Lists and IP Allow list are maintained here as well as the processing pipeline (P4 program) and associated match action rules and tables used by the SDN switch.

Still referring to FIGS. 3 and 5, the TLS Establishment Processor 72 parses the TLS Client Hello packet and evaluates the trustworthiness of the TLS termination service. Once verified, the IP address and associated server name pair are forwarded to the Local NSOEE Controller 70 to determine whether the IP allow list needs to be updated. In some embodiments this component forms part of the Local NSOEE Controller 70. However, due to the asynchronous nature of the verification, in a preferred embodiment it has been found more appropriate to provide this as a separate microservice.

Still referring to FIGS. 3 and 5, in some embodiments an Alerting/Reporting engine 74 provides for logging bypassed as well as blocked flows. In some embodiments the Alerting/Reporting engine 74 alerts the Security Operation Center (SOC, not shown) when flows are blocked and provides reasons why a given flow has been blocked. In some embodiments the Alerting/Reporting engine 74 provides alerts on allowed listing of flows.

Although the present invention has been described hereinabove by way of specific embodiments thereof, it can be modified, without departing from the spirit and nature of the subject invention as defined in the appended claims.

1. A method for forwarding packets received at an intermediate security device in a system comprising at least one client device communicating a series of packets to at least one destination server device via the intermediate security device, the method comprising:
for flow establishment packets received at the intermediate security device:
forwarding a duplicate of each of said flow establishment packets to a verifier process, said verifier process cryptographically verifying an identity of a destination IP address and claimed domain name of said flow establishment packets; and
adding verified ones of the IP destination addresses to a list of trusted IP addresses;
for packets other than flow establishment packets received at the intermediate security device:
comparing a destination IP address of each of said packets with said list of trusted IP addresses;
forwarding each of said packets without a trusted destination IP address to an addressed one of the at least one destination server device via a security service chain; and
forwarding each of said packets with a trusted destination IP address to the addressed one of the at least one destination server device while bypassing said security service chain.

2. The method of claim 1, wherein each of said flow establishment packets comprises a TLS Client Hello.

3. The method of claim 1, wherein said intermediate security device comprises a firewall.

4. The method of claim 1, wherein each of said client devices comprises a TLS application and each of said servers comprises a TLS termination point.

5. The method of claim 1, wherein said security services chain comprises at least one security service.

6. The method of claim 5, wherein said at least one security service comprises at least one of a firewall, a decryption device and web application firewall.

7. The method of claim 1, wherein the intermediate security device comprises said verifier process.

8. The method of claim 1, wherein said verifier process cryptographically verifies said destination IP address and claimed domain name of said flow establishment packets by connecting to a termination end point identified by said destination IP address and requesting a verification connection and requesting cryptographic verification.

9. The method of claim 8, wherein requesting cryptographic verification comprises Certification Revocation List (CRL) checks.

10. The method of claim 8, wherein said verifier process maintains a repository of pairs of server names and destination IP addresses for which verification has been requested and for which verification could not be established, wherein a server name and destination IP address pair for which verification could be established is checked against said repository and further wherein if either said server name of said pair is not in said repository or said server name and destination IP address pair is in said repository said server name and destination IP address pair are considered verified.

11. A system comprising:
at least one client device;
at least one server device; and
an intermediate security device for forwarding packets received from said at least one client device to said at least one server and comprising a security service chain;
wherein for flow establishment packets, said intermediate security device:
forwards a duplicate of each of said flow establishment packets to a verifier process, said verifier process cryptographically verifying an identity of a destination IP address and claimed domain name of said flow establishment packets; and
adds verified ones of the IP destination addresses to a list of trusted IP addresses;
wherein for packets other than flow establishment packets, said intermediate security device:
compares a destination IP address of each of said packets with said list of trusted IP addresses;
forwards each of said packets without a trusted destination IP address to an addressed one of the at least one server via said security service chain; and
forwards each of said packets with a trusted destination IP address to said addressed one of the at least one server while bypassing said security service chain.

12. The system of claim 11, wherein each of said flow establishment packets comprises a TLS Client Hello.

13. The system of claim 11, wherein said intermediate security device further comprises a firewall.

14. The system of claim 11, wherein each of said client devices comprises a TLS application and each of said servers comprises a TLS termination point.

15. The system of claim 11, wherein said security services chain comprises at least one security service.

16. The system of claim 15, wherein said at least one security service comprises at least one of a firewall, a decryption device and web application firewall.

17. The system of claim 11, wherein said intermediate security device comprises said verifier process.

18. The system of claim 11, wherein said verifier process cryptographically verifies said destination IP address and claimed domain name of said flow establishment packets by connecting to a termination end point identified by said destination IP address and requesting a verification connection and requesting cryptographic verification.

19. The system of claim 18, wherein requesting cryptographic verification comprises Certification Revocation List (CRL) checks.

20. The system of claim 18, wherein said verifier process maintains a repository of pairs of server names and destination IP addresses for which verification has been requested and for which verification could not be established, wherein a server name and destination IP address pair for which verification could be established is checked against said repository and further wherein if either said server name of said pair is not in said repository or said server name and destination IP address pair is in said repository said server name and destination IP address pair are considered verified.
